(19) United States
(12) Patent Application Publication
(10) Pub. No.: US 2007/0099663 A1
(43) Pub. Date: May 3, 2007

(54) Electronic Device and Access Device Thereof

(75) Inventor: Hao Chieh Li, Taipei County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/551,120

(22) Filed: Oct. 19, 2006

(30) Foreign Application Priority Data
Oct. 31, 2005 (TW) TW94138077

(51) Int. Cl. H04B 1/38; H04M 1/00

(52) U.S. Cl. 455/558

(57) ABSTRACT

An electronic device comprises an access device for receiving and accessing an object. The access device comprises a substrate, a receiver and a first elastic member. The receiver for receiving the object is rotatably disposed between a reference position and a predetermined position with respect to the substrate. The first elastic member is rotatably disposed between the substrate and the receiver. The first elastic member is for moving the receiver toward the reference position when the receiver is located at the predetermined position.

### BACKGROUND OF THE INVENTION

1. Field of the Invention

The invention relates to an electronic device and an access device thereof, and in particular to an access device for accessing predetermined object.

2. Description of the Related Art

In general, a SIM card disposed in a mobile phone cannot be easily removed and the card is difficult to dispose on a card holder. Particularly, a tendency forward damages to a user's nail during process of retrieving the card.

### BRIEF SUMMARY OF THE INVENTION

The invention provides an electronic device and an access device for easily accessing an object or card.

An electronic device comprises a card and an access device for accessing the object. The access device comprises a substrate, a receiver and a first elastic member. The receiver for receiving the object is rotatably disposed between a reference position and a predetermined position with respect to the substrate. The first elastic member is rotatably disposed between the substrate and the receiver. The first elastic member is for moving the receiver toward the reference position when the receiver is located at the predetermined position.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a perspective view of an electronic device (E) and an access device (J) thereof of a first embodiment of the invention;

FIG. 1B is an exploded view of the electronic device (E) and the access device (J) of FIG. 1A;

FIG. 2A is a perspective view the electronic device (E) and the access device (J) stored with a predetermined object (C), e.g., a card;

FIG. 2B is a perspective view of the electronic device (E) and the access device (J) stored with the object (C), wherein the object (C) is positioned at a predetermined position;

FIG. 3A is a partially enlarged view the access device (J) of FIG. 2A; and

FIG. 3B is a partially enlarged view the access device (J) of FIG. 2B.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

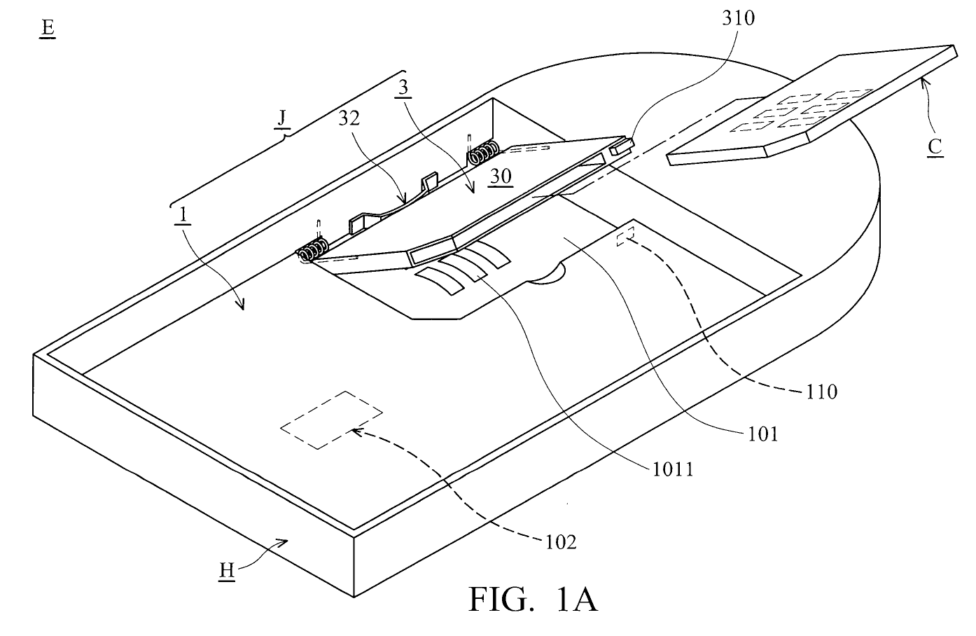

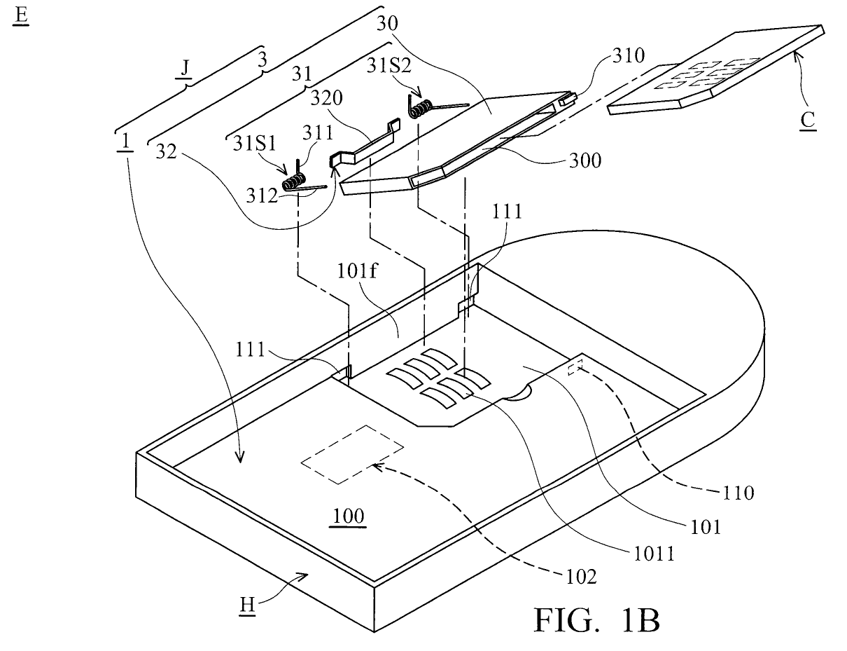

In FIGS. 1A and 1B, an electronic device E comprises a housing H, an access device J and an object C. In this embodiment, the electronic device E is a mobile phone, and the object C is a memory unit, e.g. SIM card.

The housing H is an outer structure of the mobile phone E for receiving the access device J and the object C. The access device J comprises a substrate 1 and a holding mechanism 3. The card C received in the holding mechanism 3 is positioned on the substrate 1.

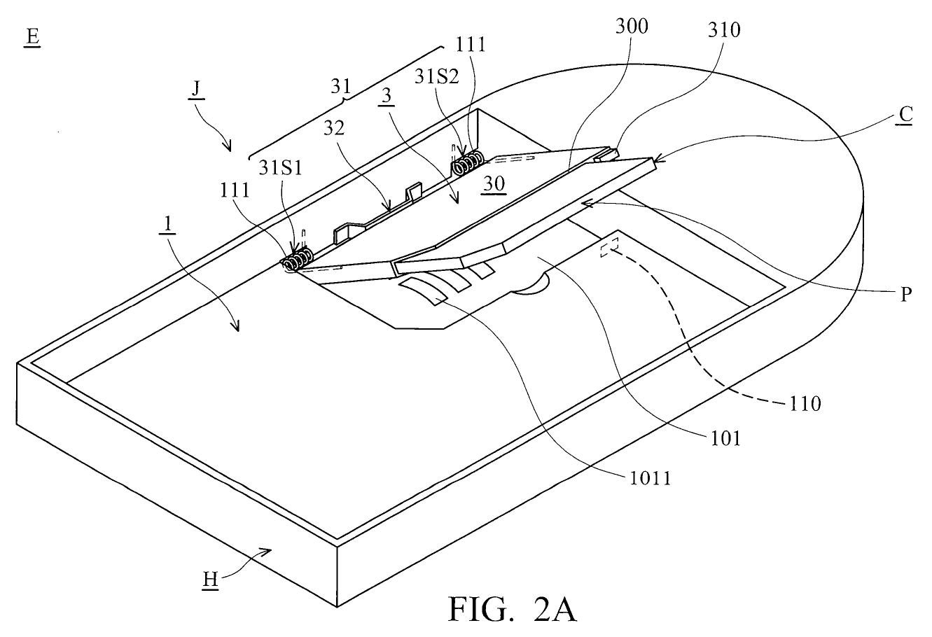

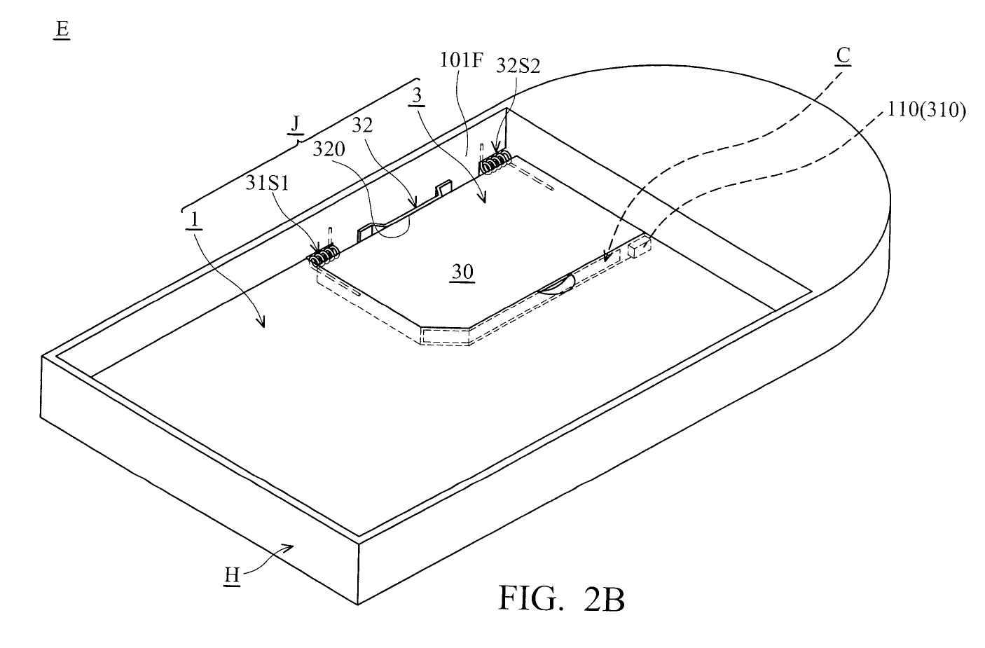

In FIGS. 2A and 2B, the access device J is respectively located at a reference position (FIG. 2A) and a predetermined position (FIG. 2B) with respect to the substrate 1. When the access device J is located at the reference position (FIG. 2A), the card C can be disposed in the access device J by an acting force P. When the access device J receiving the card C is rotated to the predetermined position (FIG. 2B) from the reference position (FIG. 2A), the card C is securely positioned on the substrate 1.

The substrate 1 comprises a base surface 100, a contact region 101 located below the base surface 100, a circuit unit 102, a first positioning portion 110 and a buffer zone 111. The contact region 101 has a plurality of contact spots 1011 electrically connected to the circuit unit 102. In this embodiment, the first positioning portion 110 is a recess formed at one side of the contact region 101, and the buffer zone 111 are composed by two recesses respectively formed on the sidewall 101 f of the contact region 101.

The holding mechanism 3 comprises a receiver 30, a first elastic member 31 disposed between the substrate 1 and the receiver 30 and a second elastic member 32 disposed on one side of the sidewall 101f of the contact region 101. The receiver 30 comprises a space 300 for accessing the card C and a second positioning portion 310 disposed next to the space 300. In this embodiment, the second positioning portion 310 is a protrusion with respect to the first positioning portion 110 of the substrate 1. The first elastic member 31 comprises a pair of torsion springs 31S1 and 31S2. The torsion spring 31S1, for example. comprises a first end 311 and a second end 312 connected to the substrate 1 and the receiver 30. respectively. Thus. the movable receiver 30 disposed between the reference position (FIG. 2A) and the predetermined position (FIG. 2B) can be positioned at the substrate 1 via the torsion springs 31S1 and 31S2. In this embodiment, the second elastic member 32 is a U-shaped reed having a contacting portion 320 facing the contact region 101.

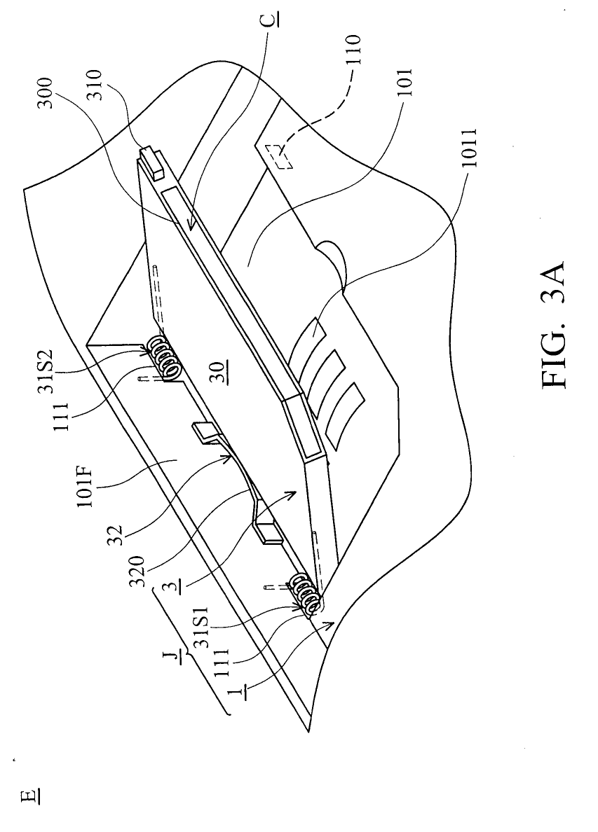

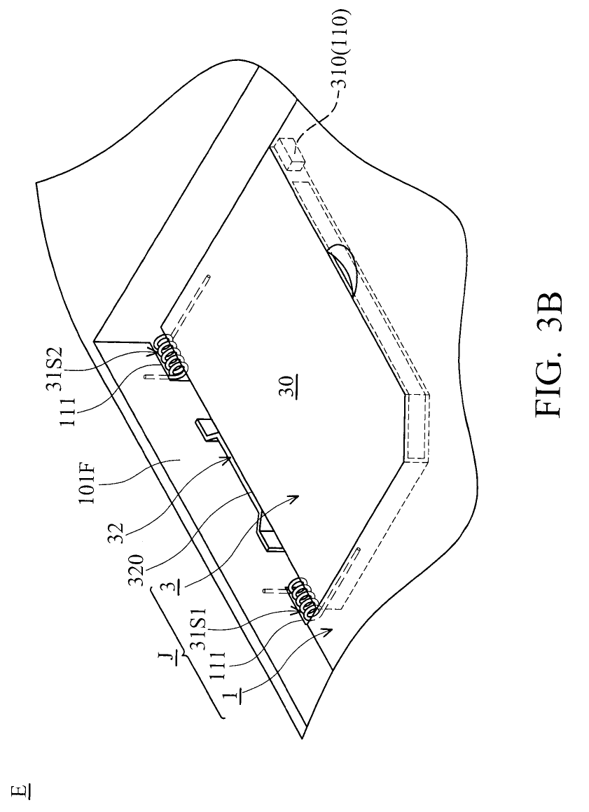

In FIGS. 3A and 3B, when the receiver 30 is rotated from the reference position (FIG. 2A) to the predetermined position (FIG. 2B), the deformed torsion springs 31S1 and 31S2 of the first elastic member 31 correspondingly exert a rebound or recover force to return the receiver 30 to the reference position (FIG. 2A). That is to say, when the receiver 30 is released between the reference position (FIG. 2A) and the predetermined position (FIG. 2B), the receiver 30 is automatically returned to the reference position (FIG. 2A.

When the receiver 30 is rotated to the predetermined position (FIG. 2B), the contacting portion 320 of the reed 32 pressing on the receiver 30 keeps the second positioning portion 310 properly located at the first positioning portion 110. Thus, the receiver 30 is fixedly positioned at the predetermined position (FIG. 2B) and the card C received in the holding mechanism 3 is electrically connected to the contact spots 1011 of the contact region 101.

Conversely, when the holding mechanism 3 is moved to push the reed 32 and disengage the second positioning portion 310 from the first positioning portion 110, the holding mechanism 3 can be automatically returned to the reference position (FIG. 2A) while the applied acting force is gradually or suddenly released. Thus, the card C can be removed.

Note that the deformed portion of the first and second elastic members 31 and 32 can freely pass through the buffer zone 11. Thus, the holding mechanism 3 can be smoothly rotated between the reference position (FIG. 2A) and the predetermined position (FIG. 2B).

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An access device for receiving and accessing an object, comprising:
a substrate;
a receiver, disposed on the substrate, for receiving the object, rotatable with respect to the substrate between a reference position and a predetermined position; and
a first elastic member rotatably disposed between the substrate and the receiver, wherein the first elastic member is for moving the receiver toward the reference position when the receiver is located at the predetermined position.

2. The access device as claimed in claim 1, wherein when the receiver is released at the reference position, the receiver automatically moves from the reference position to the predetermined position.

3. The access device as claimed in claim 1, wherein the first elastic member comprises a torsion spring.

4. The access device as claimed in claim 1, wherein the substrate comprises a buffer zone allowing the first elastic member to stretch therethrough.

5. The access device as claimed in claim 1 further comprising a second elastic member disposed between the substrate and the receiver.

6. The access device as claimed in claim 5, wherein the second elastic member comprises a contacting portion contacting the receiver when the receiver is located at the reference position.

7. The access device as claimed in claim 6, wherein the second elastic member comprises a reed.

8. The access device as claimed in claim 1, the substrate comprising a first positioning portion and the receiver comprising a second positioning portion, wherein the second positioning portion is coupled to the first positioning portion when the receiver is located at the reference position.

9. An electronic device for receiving and accessing an object, comprising an access device for accessing the object, the access device comprising:
a substrate;
a receiver for receiving the object, rotatable with respect to the substrate between a reference position and a predetermined position; and
a first elastic member rotatably disposed between the substrate and the receiver, wherein the first elastic member is for moving the receiver toward the reference position when the receiver is located at the predetermined position.

10. The electronic device as claimed in claim 9, wherein when the receiver is released at the reference position, the receiver automatically moves from the reference position to the predetermined position.

11. The electronic device as claimed in claim 9, wherein the substrate comprises a buffer zone allowing the first elastic member to stretch therethrough.

12. The electronic device as claimed in claim 9 further comprising a second elastic member disposed between the substrate and the receiver.

13. The electronic device as claimed in claim 12, wherein the second elastic member comprises a contacting portion contacting the receiver when the receiver is located at the reference position.

14. The electronic device as claimed in claim 12, wherein the second elastic member comprises a reed.

15. The electronic device as claimed in claim 9, the substrate comprising a first positioning portion and the receiver comprising a second positioning portion, wherein the second positioning portion is coupled to the first positioning portion when the receiver is located at the reference position.
